(19) United States
(12) Patent Application Publication
(10) Pub. No.: US 2017/0295217 A1
(43) Pub. Date: Oct. 12, 2017

(54) METHOD AND SYSTEM OF APPLICATION DEVELOPMENT FOR MULTIPLE DEVICE CLIENT PLATFORMS

(71) Applicant: EVADO HOLDINGS PTY LTD, MELBOURNE (AU)

(72) Inventor: Ross ANDERSON, MELBOURNE (AU)

(21) Appl. No.: 15/628,669

(22) Filed: Jun. 21, 2017

Related U.S. Application Data
(63) Continuation of application No. 14/383,903, filed on Sep. 9, 2014, now abandoned.

(30) Foreign Application Priority Data
Mar. 10, 2012 (AU) 2012900965

(51) Int. Cl. H04L 29/08; G06F 17/30; H04L 29/06

(52) U.S. Cl. CPC H04L 67/02; H04L 67/10; H04L 67/42; G06F 17/30893

(57) ABSTRACT

A client server environment having a server with a Web service in communication with a local client application which is tightly integrated with its local operating environment residing on a platform remote from the server; the local client application tightly integrated by way of integrating data structures requested and received from the server; the integrating data structures defining the attributes and parameters needed by the local client application to define an interface between the local client application and the Web service. The integrating data structures enable tight/close integration between the hosted application and the devices and the operating system features of the platform upon which the local client application resides. Also disclosed is an abstracted environment which can run on any one of the supported platform's devices as a native application, all based on the passing of the same page commands and receipt of corresponding client data objects between the server and the client applications; the data objects being identical irrespective of the platform. In a preferred form, the device application interface for each local platform is tightly integrated with the client application whereby the abstracted environment appears to run as a native application on the platform.

The present invention relates to a client server environment and associated data structures, and, more particularly, to such an environment and structures which permit, inter alia, in preferred forms, application development for multiple device client platforms, and the development of such applications which are tightly integrated with the features of the device client platforms, including the input/output features of those platforms.

### BACKGROUND

Web browsers are well known in the art. The page layout and format instructions and the data come from a server. Often this information is accompanied by certain limited basic executable instructions stored locally in a cache by the browser application. An example of this is the code language called JavaScript.

Alternatively, native applications that reside on the machine may interact with a server, often over the Internet. However, in this case, the user interface, executable code and the interaction with the computer environment are all handled and initiated by the native application.

In practice, these two application models have limitations.

By design, the browser has a very limited scope of execution and can only interact with the operating system in a limited way using a limited storage area commonly called a sand box in the art. However browsers have an advantage in that they are designed to be compatible across many hardware and operating system platforms thereby allowing one set of format, data and limited executable code to be provided for all platforms leading to distribution and programming efficiencies.

On the other hand, even though native applications have unlimited scope of operation and can usually interact with the operating system at all levels, the engineering involved in producing this application must be customized for each platform on which the application is to run. This is despite the fact that often it is desirable to produce the same application with the same functionality across multiple computing platforms.

Embodiments of the invention are intended to address these issues.

### PRIOR ART DISCUSSION

FIG. 1 provides an example of the existing components of a network aware native application as known in the art. The example includes an application server, which is often a database 10, the Internet 11, and two examples of local computers 12, 14.

The local computer 12 may include an Internet browser application 13. In an Internet browser application 13 the page information is downloaded from the remote application server 10. The information contains the page layout, page content and executable scripts often called java scripts to automate page actions. Due to the nature of the web browser, it is not able to directly interact with the local computers 12 operating system. As a result it is very difficult to access local devices like cameras, GPS location and barcode scanners.

A second example computer 14 features local native application 15 that interfaces with the operating systems 16 and local devices 17 that are attached to, or comprise part of the computer. The local application 15 is able to directly interact with both the local devices 17 and the remote application server 10 through a network and the Internet 11. Information collected by the local computer's devices 17 can be processed and passed to the remote application server 10. For example, a barcode scanner can read a bar code and then pass the code to the remote application server to retrieve additional information associated with the barcode.

The local application 15 can communicate with the operating system 16 to store local application specific information or access other data or services operating within the operating system 16. While the local application has the capability of providing an integrated native application environment, it is necessary to develop native applications for each of the separate and distinct device platforms the application is intended to run upon by the publisher.

This is not desirable, since software publishers often would like to sell their software to users independent of what hardware or operating system platform the customer is using. In addition, when new features are to be implemented, it is necessary to upgrade and replace the native applications that run on each of the differing operating systems and hardware platforms.

It is an object of the present invention to address these perceived shortcomings of the prior art.

### Notes

The term ‘comprising’ (and grammatical variations thereof) is used in this specification in the inclusive sense of ‘having’ or ‘including’, and not in the exclusive sense of ‘consisting only of’.

The above discussion of the prior art in the Background of the invention, is not an admission that any information discussed therein is citable prior art or part of the common general knowledge of persons skilled in the art in any country.

### BRIEF DESCRIPTION OF INVENTION

In this specification, the following terms have the meanings as outlined:

Data Structure is a binary, json or XML structure that contains data that are transferred between two applications.

Application Programming Interface (API) are recognised in the art as external interfaces to: application code blocks or libraries that allow an external application to interface or interact with the application providing the interface. APIs can also be serialised into XML data structure and passed between Application Servers and Application Clients.

Client Computer is computer, including desktop and laptop PCs or Mobile Devices.

Server is a computer that is used to host one or more applications or services that can be accessed locally or via an Application Client. E.g. Application Server or Web Server or Web Service.

Native Application is an application that runs on a Client Computer or Platform running a specific type of computer operating system. That can have one or more external interfaces that can be used to communicate with other applications running on other computers (servers). A native application is able to access other local services running on the Client Computer, e.g. Camera, Audio recording, GPS coordinates etc.

Application Server is a Server running an application that has external interfaces, e.g. Internet protocols, to interface with an Application Client.

Application Client is an application running on a Client Computer whose sole purpose is to interface with an Application Server.

Web Server is an Application Server that communicates with Web browsers using W3C standards and protocols.

Web Browser is an application that runs on a Client Computer and communicates with a Web Server using W3C standards and protocols to display and interact with the Web Server's application.

Web Service is a service running on a Web Server that connects to one or more Application Clients running a Web Client using W3C standards and protocols over an SSL connection.

Web Client is an Application Client that connects to a Web Service using W3C standards and protocols.

Application Service is an Application Server running a Web Service that is able to interface to multiple Client Computers running a variety of different operating systems, including Mobile Devices.

Mobile Device is a portable computing device that can connect to the Internet over mobile telephone networks or wireless networks. That is able to run a number of Mobile Applications.

Mobile Application (Mobile App) is a Native Application that is running on a Mobile Device that typically connects to an Application Service.

Device Application Interface provides a generalised Data Structure that is used on connect the Application Client with the Application Service. This interface allows different Mobile Devices with different functional capabilities to interact with an application using a common set of data and device client API.

Device Application is an application that is executed using the Application Service and the Application Client architecture outlined in this specification.

Device Application Data is serialised instance of the data that is passed across Device Application Interface between the Application Service and the Application Client.

Server Object is a class object that contains methods for generating and processing Device Application Data on the Application Service, calling relevant classes and methods in the Hosted Application and interacting with the Device Application.

Hosted Application is an application that is running on the Server that is accessed via one or more server objects.

Accordingly, in one broad form of the invention, there is provided, in a client server environment having a server with a Web service in communication with a local client, a method of tightly integrating the local client to its local operating environment residing on a platform remote from the server; said method comprising the steps of

(a) installing the local client into the local operating environment;

(b) requesting and receiving integrating data structures from the server; and

(c) downloading the integrating data structures into the local operating environment whereby the integrating data structures define the attributes and parameters needed by the local client to define an interface between the local client and the Web service.

Preferably, the integrating data structures themselves are communicated between the server and the local client utilising a device independent protocol.

Preferably, the device independent protocol comprises a command set which is the same irrespective of the local operating environment or the platform.

Preferably, the platform is a mobile digital device or local computer.

Preferably, at least some of the integrating data structures are included with the local client at the time of installation.

Preferably, at least some of the integrating data structures enable the Web service to have programmable access to at least some features of the local device.

Preferably, features of the local device include input/output devices.

Preferably, features of the local device include data acquisition devices.

Preferably, the method further includes the step of installing the integrating data structures into the local operating environment, whereby the integrating data structures define the attributes and parameters needed by the local client to define an interface between the local client and the local operating environment.

Preferably, the integrating data structures include elements of a local device application interface, which permits the local client to access features of at least one local device as though the local client were a native application of the local operating environment residing on the platform.

Preferably, the integrating data structures include script libraries which provide a programmable interface between the local device features and the local client, and whereby the Web service has programmable access to the local device features.

Preferably, the script libraries include a local command whose button events will call scripts to perform local processing of page data or the local devices.

Preferably, selected ones of the script libraries comprise a library of scripts that can be executed on all supported devices.

Preferably, the script library comprises a library of JavaScript functions.

Preferably, the integrating data structures are implemented by the step of calling a method on the Web service and passing to it a pre-determined command object containing the command name and the parameters needed to execute the command.

Preferably, the Web service returns pre-determined integrating data structures relevant to the pre-determined command object.

Preferably, the pre-determined integrating data structures:

(a) define the page;

(b) define the page groups (as a list of groups);

(c) define the field object containing the parameters needed to define the field type, any validation rules needed for that field, and parameter settings needed to enable or access local devices on the local client; and

(d) define commands that can be executed by the local client, so that, when clicked, the command button sends the relevant command object to the Web service.

Preferably, the Web service has full control of the page definitions.

Preferably, an unlimited number of different page definitions can be passed to the local client from the Web service.

Preferably, the method further includes the step of utilising device independent data structures to send and receive data between the web service application and application client.

Preferably, the device independent data structures define the attributes and parameters needed to define the user interface and access the local devices feature.

Preferably, the device independent data structures define the attributes and parameters of the commands sent from the application client to the web service application.

Preferably, the data structures define access to a camera connected to the platform.

Preferably, the web service application contains a number of server objects, to process the requests from the application client and generate the device independent data structures needed to define the web service application data to be displayed on the mobile device and any requests access to local computing features.

Preferably, the device client processes the device independent data structures, in order to generate web service application pages using the device's native user interface.

Preferably, the device client processes the device independent data structures, in order to facilitate access to the local platform features and send command requests to the web service application.

Preferably, the device client contains a device independent interface to integrate the device client with local computing platform features, thereby enabling the web service application either manually or under program control to access the local computing platform features.

Preferably, the device independent data structures support the clustering of common fields to provide user navigation between field groups when using platforms comprising computing devices with small form factors while supporting multiple field data types and data validation.

Preferably, the device independent data structures are extended to support the storage of application data and scripting, thereby to facilitate integration with common or pre-loaded data and extend the application client's functionality,

Preferably, the device independent data structures support offline operation.

Preferably, the device independent data structures are extended to support local client site scripting, thereby to enhance the application functionality that can be executed on client,

Preferably, the device independent data structures are extended to support JavaScript access to application functions.

Preferably, the page commands contain sufficient information to send a command to the web service application, and to identify the application objects to be accessed, the action the web service application is to perform and the parameters needed to complete the action.

Preferably, when a user of the web service application clicks a device client command on the user interface, the command request is sent to the web service application from the device client, to be processed by the web service application.

Preferably, the web service application, on receipt of the command request from the device client, processes the command and generates the appropriate device independent data structures, which are returned to the mobile device client.

Preferably, the method includes the step of replacing the local client with a test harness that can execute test scripts, thereby to automate application testing.

Preferably, the platforms on which device clients can run include Microsoft Windows, Mac OS X operating systems, or a Web interface to the hosted application.

In a further broad form of the invention, there is provided a client server environment having a server with a Web service in communication with a local client which is tightly integrated with its local operating environment residing on a platform remote from the server; the local client tightly integrated by way of integrating data structures requested and received from the server; the integrating data structures defining the attributes and parameters needed by the local client to define an interface between the local client and the Web service.

Preferably, the integrating data structures themselves are communicated between the server and the local client utilising a device independent protocol.

Preferably, the device independent protocol comprises a command set which is the same irrespective of the local operating environment or the platform.

Preferably, the platform is a mobile digital device or local computer.

Preferably, at least some of the integrating data structures are included with the local client at the time of installation.

Preferably, at least some of the integrating data structures enable the Web service to have programmable access to at least some features of the local device.

Preferably, features of the local device include input/output devices.

Preferably, features of the local device include data acquisition devices.

Preferably, the environment further includes the installation of the integrating data structures into the local operating environment, whereby the integrating data structures define the attributes and parameters needed by the local client to define an interface between the local client and the local operating environment.

Preferably, the integrating data structures include elements of a local device application interface, which permits the local client to access features of at least one local device as though the local client were a native application of the local operating environment residing on the platform.

Preferably, the integrating data structures include script libraries which provide a programmable interface between the local device features and the local client, and whereby the Web service has programmable access to the local device features.

Preferably, the script libraries include a local command whose button events will call scripts to perform local processing of page data or the local devices.

Preferably, selected ones of the script libraries comprise a library of scripts that can be executed on all supported devices.

Preferably, the script library comprises a library of JavaScript functions.

Preferably, the integrating data structures are implemented by the step of calling a method on the Web service and passing to it a pre-determined command object containing the command name and the parameters needed to execute the command.

Preferably, the Web service returns pre-determined integrating data structures relevant to the pre-determined command object.

Preferably, the pre-determined integrating data structures:

(a) define the page;

(b) define the page groups (as a list of groups);

(c) define the field object containing the parameters needed to define the field type, any validation rules needed for that field, and parameter settings needed to enable or access local devices on the local client; and

(d) define commands that can be executed by the local client, so that, when clicked, the command button sends the relevant command object to the Web service.

Preferably, the Web service has full control of the page definitions.

Preferably, an unlimited number of different page definitions can be passed to the local client from the Web service.

Preferably, the environment further includes the step of utilising device independent data structures to send and receive data between the web service application and application client.

Preferably, the device independent data structures define the attributes and parameters needed to define the user interface and access the local devices feature.

Preferably, the device independent data structures define the attributes and parameters of the commands sent from the application client to the web service application.

Preferably, the data structures define access to a camera connected to the platform.

Preferably, the web service application contains a number of server objects, to process the requests from the application client and generate the device independent data structures needed to define the web service application data to be displayed on the mobile device and any requests access to local computing features.

Preferably, the device client processes the device independent data structures, in order to generate web service application pages using the device's native user interface.

Preferably, the device client processes the device independent data structures, in order to facilitate access to the local platform features and send command requests to the web service application.

Preferably, the device client contains a device independent interface to integrate the device client with local computing platform features, thereby enabling the web service application either manually or under program control to access the local computing platform features.

Preferably, the device independent data structures support the clustering of common fields to provide user navigation between field groups when using platforms comprising computing devices with small form factors while supporting multiple field data types and data validation.

Preferably, the device independent data structures are extended to support the storage of application data and scripting, thereby to facilitate integration with common or pre-loaded data and extend the application client's functionality,

Preferably, the device independent data structures support offline operation.

Preferably, the device independent data structures are extended to support local client site scripting, thereby to enhance the application functionality that can be executed on the client.

Preferably, the device independent data structures are extended to support JavaScript access to application functions.

Preferably, the page commands contain sufficient information to send a command to the web service application, and to identify the application objects to be accessed, the action the web service application is to perform and the parameters needed to complete the action.

Preferably, when a user of the web service application clicks a device client command on the user interface, the command request is sent to the web service application from the device client, to be processed by the web service application.

Preferably, the web service application, on receipt of the command request from the device client, processes the command and generates the appropriate device independent data structures, which are returned to the mobile device client.

Preferably, the environment further includes the step of replacing the local client with a test harness that can execute test scripts, thereby to automate application testing.

Preferably, the platforms on which device clients can run include Microsoft Windows, Mac OS X operating systems, or a Web interface to the hosted application.

In yet a further broad form of the invention, there is provided a method of providing a development environment for an application operable as a served application from a Web service; the served application operable on a plurality of pre-determined platforms.

In yet a further broad form of the invention, there is provided a device application interface containing a generalised data structure containing code adapted to interface multiple predetermined digital devices to an application executing on a selected one said digital devices; said device application interface including multiple instances of code; each instance adapted to provide a tightly bound interface between said application and a said selected digital device.

Preferably, said tightly bound interface is to an operating system of said selected digital device thereby to provide direct access to all input-output functions of said selected digital device.

Preferably, said device application interface provides a user environment which appears to be a native application to a user.

In yet a further broad form of the invention, there is provided a client server structure comprising at least one instance of an application service running on a server; said application service in remote communication with an application client running on a selected digital device.

In yet a further broad form of the invention, there is provided a method of communication between a device application served by a Web service and one or more pre-determined local clients running on pre-selected supported platforms; said method utilising protocols for communication between the Web service and the one or more pre-determined local clients which are substantially the same irrespective of the pre-determined local client or the pre-selected supported platform, thereby to permit the Web service to be closely integrated with the local client.

Preferably, there is close integration between the features supported by the local client and the device application served by the Web service.

Preferably, the close integration includes the provision of a secure environment for the local client.

In yet a further broad form of the invention, there is provided a client server environment and associated data structures, which permit application development for multiple device client platforms; the environment further enabling the development of such applications which are tightly integrated with the features of the device client platforms, including the input/output features of those platforms.

In yet a further broad form of the invention, there is provided an abstracted environment which can run on any one of the supported platform's devices as a native application, all based on the passing of the same page commands and receipt of corresponding client data objects between the server and the client applications; the data objects being identical irrespective of the platform.

Preferably, the device application interface for each local platform is tightly integrated with the client application, whereby the abstracted environment appears to run as a native application on the platform.

In yet a further broad form of the invention, there is provided a client application adapted to run on a local platform under the environment as defined above.

In yet a further broad form of the invention, there is provided a Web service adapted to run on a server under the environment as defined above.

In yet a further broad form of the invention, there is provided a non-transitory computer-readable medium for carrying or having computer-executable instructions or data structures stored thereon which, when executed on a platform, performs the method as defined above.

In yet a further broad form of the invention, there is provided a non-transitory computer-readable medium for carrying or having computer-executable instructions or data structures stored thereon which, when executed on a server, performs the method as defined above.

### BRIEF DESCRIPTION OF DRAWINGS

FIG. 1 illustrates, in block diagram form, current Internet-aware computer application components (prior art).

FIG. 2 illustrates, in block diagram form, an example embodiment of the present invention including network connections to multiple hardware and operating system platforms.

FIG. 3 illustrates, in block diagram form, an example embodiment of the present invention disclosing its main components.

FIG. 4 illustrates a prior art arrangement using an HTML interface.

FIG. 5 illustrates, in block diagram form, an embodiment of the Device Application Object structure.

FIG. 6 is a diagram illustrating client server interaction including Application Service and Application Client interaction in accordance with an embodiment of the invention.

FIG. 7 illustrates an example of a Device Application homepage in accordance with an embodiment of the invention.

FIG. 8 illustrates code snippets for client data objects and client page commands in accordance with an embodiment of the invention.

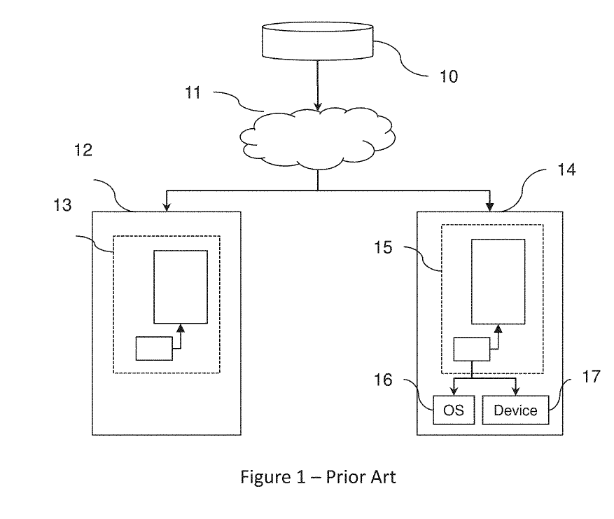

### DETAILED DESCRIPTION OF PREFERRED EMBODIMENTS

A generic example embodiment has been included in this specification, as embodiments of this invention may be implemented across a wide variety of technology platforms and frameworks. The implementation for different specific platforms or frameworks may vary substantially while having the same core structure, functions and processes as outlined below.

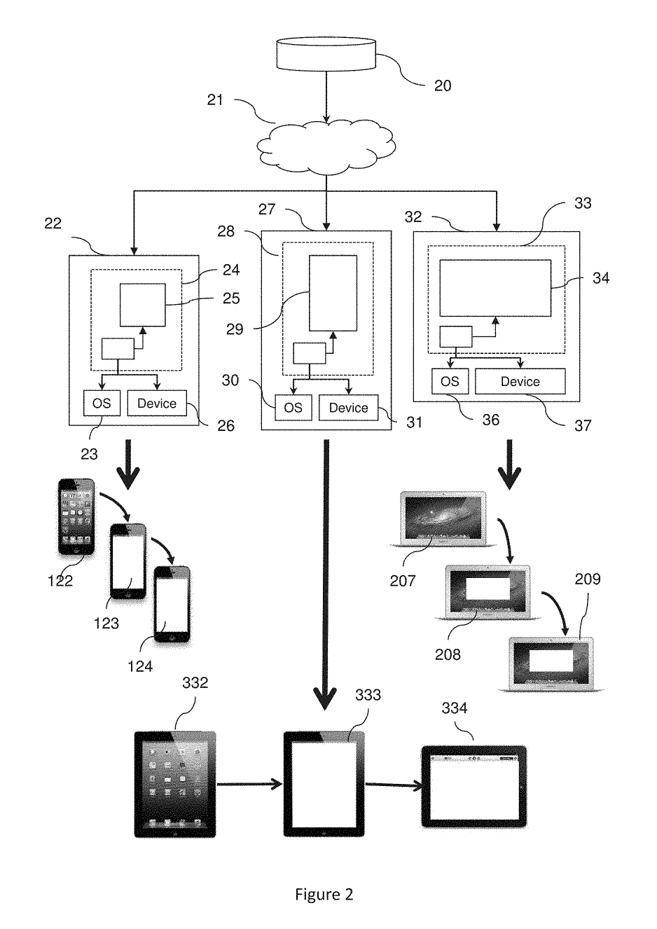

FIG. 2 describes an embodiment of the invention using client server architecture and device independent protocols, including a network connection 21 to multiple computers 22, 27, 32 running with different hardware and operating system platforms. The computers or devices 22, 27, 32 are connected with a network to the Application Server 20, in this instance by means of the Internet 21.

The first example computer 22 may be a smart phone such as an iPhone (Mobile Device). The next computer 27 may be an iPad (Mobile Device). And the third example platform 32 may be a laptop or desktop computer (Client Computer). Each of the computers 22, 27, 32, are running different operating systems 23, 30, 36. The computers 22, 27, 32 a native Application Client 24, 28, 33 application is installed on each platform.

On request each of the Application Client 24, 28, 33, download the same integrating data structures in the form of Device Application Data 25, 29, 34 from the Application Service 20. Once the Device Application Data 25, 29, 34 is downloaded and deserialised it can be executed resulting in a connection between the Device Application to the computer's operating system 23, 30, 36 and components 26, 31 and 37 such as the camera's audio functions or network capabilities.

The Device Application Data object 25, 29, 34, 60 and Page Command object integrates the hosted Application functions running on the Application Service 20 with mobile device 22, 27, 32, 40 via the Application client.

More specifically, with reference to FIG. 2, iPhone 122 has the device client installed, the user launches the Application Client 123, where the user logs in and is authenticated with the Application Service 20, the authenticated user is directed to the Device Application home page 124. The iPhone Application Client automatically formats the page to fit the device format and orientation.

FIG. 2 MacBook 207, has the device client installed, the user launches the Application Client 208, where the user logs in and is authenticated with the Application Service 20, the authenticated user is directed to the Device Application home page 209. The Mac X10.8 Application Client automatically formats the page to fit the device format and orientation.

FIG. 2 iPad 332, has the device client installed, the user launches the Application Client 333, where the user logs in and is authenticated with the Application Service 20, the authenticated user is directed to the Device Application home page 334. The iPad Application Client automatically formats the page to fit the device format and orientation.

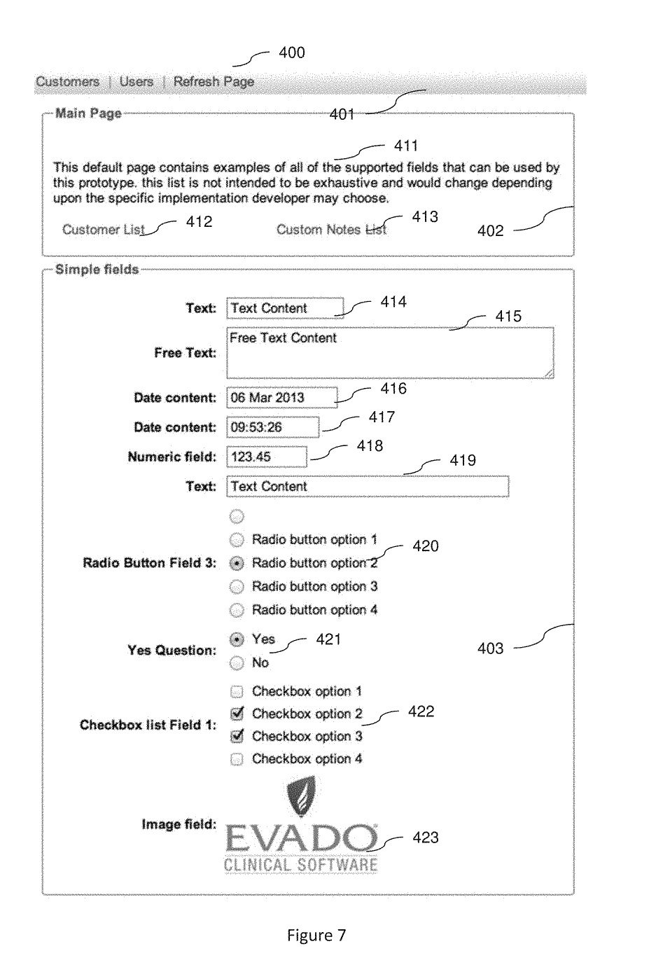

With reference to FIG. 7, the Device Application homepage 400 may take the form as illustrated showing the page menu 401 consisting of one or more commands, various supported groups 402, 403, group commands 412, 413 and fields 411, 414, 415, 416, 417, 418, 419, 420, 421, 422, 423.

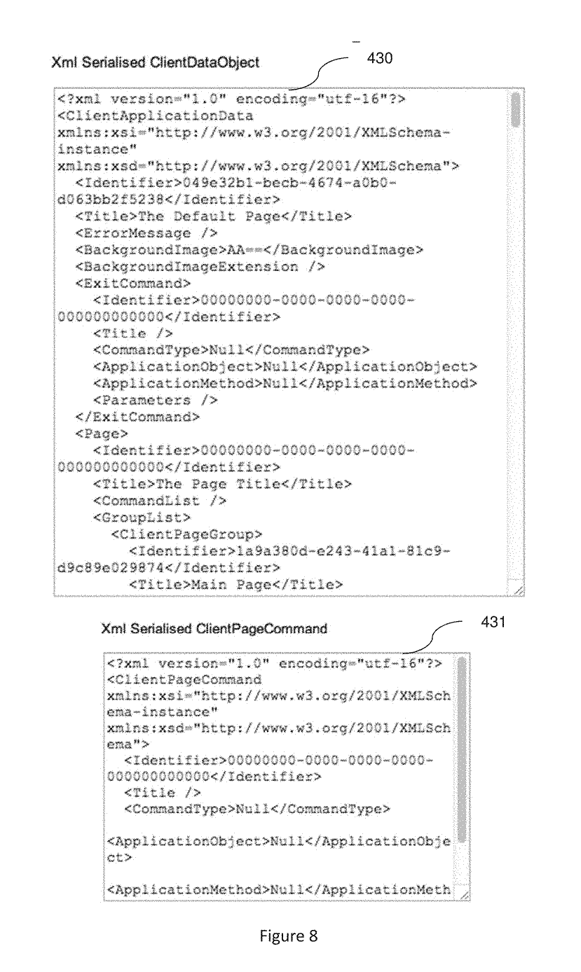

Because of the close integration between the server and the clients (on the various platforms), the programmer can effectively control the entire client's behaviour/page. In effect, the exemplary arrangement of FIG. 8 provides an abstracted environment 41, which can run on any one of the supported platform's devices 26, 31, 37 as a native application, all based on the passing of the same page commands 431 and receipt of corresponding client data objects 430 (refer FIG. 8) between the server and the client applications, which are identical irrespective of the platform 26, 31, 37.

In particular, the tight integration implemented between the device application interface for each local platform with the client application means that the abstracted environment 41 appears to run as a native application.

There is thus provided a powerful, flexible interface which permits the downloading and running of multiple applications across multiple supported platforms. Because of the identical command structures used across the platforms, the testing of new applications is rendered relatively straightforward, and does not inherently require testing on every supported platform.

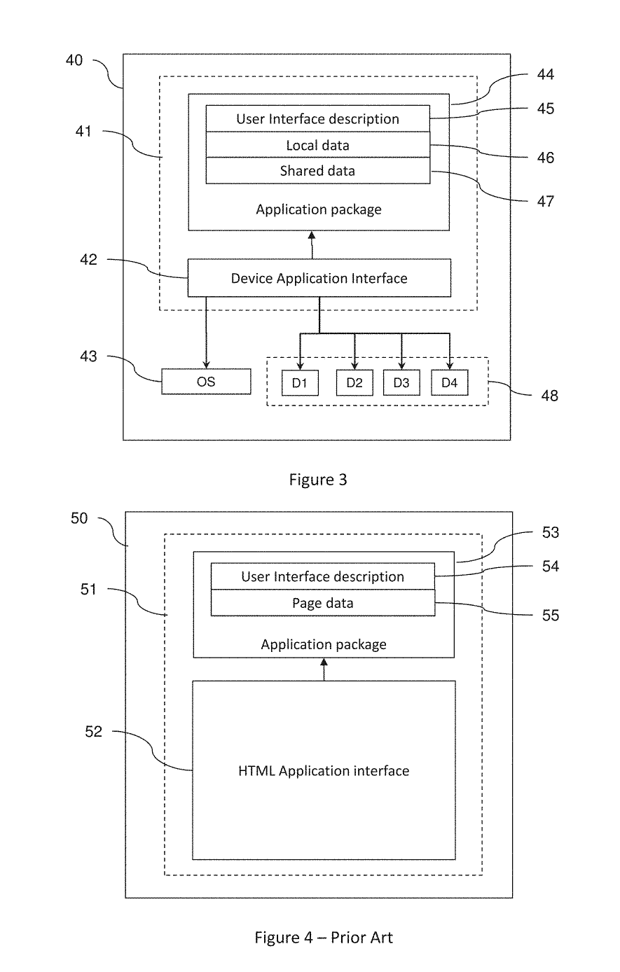

FIG. 3 discloses an example embodiment of the invention in greater detail on one platform 40. The local computer 40 is running the Application Client 41. The Application Client 41 contains a Device Application Interface 42. The Device Application Data 44 may consist of a user interface description 45, local data 46 and data that is shared 47 between the local device and the application server on the Internet or other devices on the network.

The Device Application Interface 42 connects the Device Application Data 44 with the computer's operating system 43 and local device components 48. The Device Application Interface 42 can operate as a protocol converter to provide a standardised application interface to allow the downloaded Device Application Data 44 to communicate with and control local device components 48 and also provides the access to the native operating system 43 features and access to the native user interface objects.

In this example the Device Application Data 44 is downloaded to all of the devices running the Application Client 41, 24, 28, 33 from the Application Service 20. Once the Device Application Data 44 has been downloaded, it is able to interact with the local computer 43 via the Device Application Interface 42 to provide a user environment that appears to be a native application to the user.

The Application Client 41 lets the Device Application Data 44, store local data 46 and shared data 47 downloaded from the Device Application Interface Application Server 20. This provides the Device Application Data 44 with the capability to operate while not connected to the Internet 21 and synchronise shared data with the Application Service 20 when Internet 21 connectivity is restored.

Once the Application Client 41 has been developed to run on each of the devices the publisher intends to use, additional features and functionality can be added to the downloadable Device Application Data 44 without having to update the Application Client 41. The Application Client 41 only needs to be updated to take advantage of new operating system features or devices as they are added.

In contrast, FIG. 4 discloses a sample embodiment of a prior art web browser in greater detail on one platform 50. The local computer 50 is running the web browser 51. The Web Browser 51 contains an html interface 52 and html data objects 53, containing a user interface description 54, local data 55.

In this example the html data objects 53 is downloaded to the local computer 50 from the Web Server 10. Once the html data objects have been downloaded, it is able to interact with web browser 51, to display the contents of the html objects using a html display layout.

Due to the sandbox isolation of the web browser 51, it is not possible for the HTML objects to directly access the local computer's operating system or devices. This limits the ability of the web application to access and control the local computer's operating system functions.

A number of software vendors provide web browser 51 add-ons, to extend the functionality of the browser, however add-ons potentially provide an opportunity for hackers to by-pass the web browser sandbox security and directly access the operating system and its local devices.

### Example Embodiment

To implement the sample embodiment above it is necessary to implement an Application Service 10, 20, Application Client 24, 28, 33, 41 running on the targeted Mobile Device 22, 27, 32, 40 and the Device Application Data 25, 29, 34, 44 object that acts as the interface and object transporting data to and from Application Service.

This example embodiment excludes a number of platform framework dependent functions, such as: user authentication, session management, user role access, object caching and load management, to simplify the description of the functions and processes of the preferred embodiments. It is assumed that a commercial implementation of embodiments of the invention would include the relevant platform or framework functions to control user access and optimise server and web service performance.

The following outlines the structure methods of the Application Service, Application Client and Device Application Data object.

### Device Application Data Structure

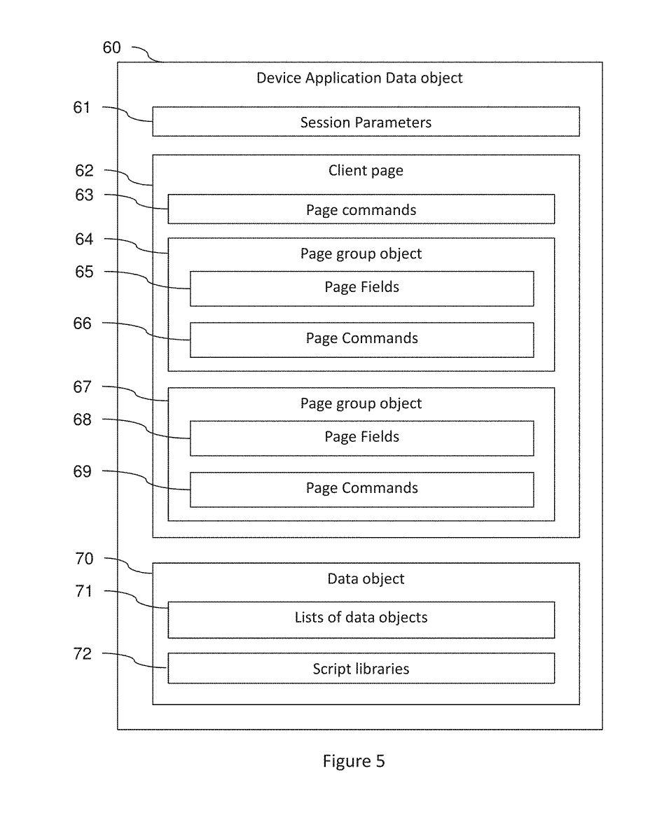

FIG. 5 contains an example embodiment of the Device Application Data 60 objects structure. This example embodiment contains the following elements:

(a) session parameters 61 contain the parameters needed for the Application Client to maintain its session with the Application Service. These parameters are returned to the Application Service when the Application Client sends a web service request;

(b) client page 62 object defines the page structure to be displayed on the Application Client 24, 28, 33, 41. Alternative embodiments could utilise lists of Client pages 62 objects that would allow the Application Client 24, 28, 33, 41, to display multiple different pages without having to interact with the Application Service 10, 20. A client Page 62 object would typically contain:
(i) A Page Command 63 objects containing the commands that can be executed on the page;
(ii) One or more Page Group 64, 67 objects containing one or more Page Command Objects 65, 68 and none or more Page Field objects 63, 69.

(c) Data Object 70, containing lists of Data Objects 71 that can be referenced by a Client Page 62.

(d) A Script Library 72 can be a library of scripts that can be executed on all supported devices. E.g. Libraries of Java Script Functions.

The Page Commands 63, contains Page Command objects. The Page Command object contains the parameters necessary to send command request from the Application Client 41 to the Application Service 10, 20. These could include:

(a) Type of command: local, server or a command to open an HTTP link.

(b) A command identifier

(c) The command name or title.

(d) The command parameters including references to identify the Hosted Application object to be called, object's method to be called, and a list of method parameters to be passed to the method.

The Page Group 64 and 67 contains a collection of Page Field objects 65, 68 objects and a collection, a collection of Page Command objects 66, 69.

The Page Field objects 65, 68 contain the necessary components to enable an Application Client 41, to display field data of various types. These components could include:

(a) a field identifier;

(b) field title;

(c) field value, e.g. text, numeric, data, byte;

(d) field data type; and/or

(e) field validation data.

The invention's architecture has been designed to provide the application designer with flexibility to customise Device Application Data 60, the associated Application Service 10, 20 and the Application Client 41 features to meet their specific application's requirements.

### Application Service Operation

Application Service 20 provides:

(a) connects with the Application Client 24, 28, 33, 41;

(b) manages the Application Client's session with the Application Service, including the authentication with the application service;

(c) interfaces to the Hosted Application, using its Server Object, classes and methods.

When the Application Service 20 receives a login request, the user's credentials are passed to the authentication source or provider.

(a) If the credentials are authenticated, the Application Service:
(i) creates a user session;
(ii) accesses the Hosted Application do define the users access;
(iii) returns the default page. Containing the user's Session Parameters.

(b) If the authentication fails the user is requested to re-enter their credentials.

Application Service 20 consists of a number of Server Objects that are used to interface the Application Service 20 with the Hosted Application. These classes provide a standardised set of functions or methods to generate and process the data that is passed between Application Service 20 and Application Client 24, 28, 33, 41, by calling the relevant Hosted Application classes and methods.

A Server Object contains the application code needed to execute the Hosted Application's classes and methods. The Server Object receives one or more Page Commands object as parameters and returns the Device Application Data defining the page to be displayed on the Application Client.

The called method, interfaces with the relevant Hosted Application classes and methods to execute the Page Command parameters. The results from the calls to the Hosted Application methods are processed to generate a Device Application Data object, which is returned to the web method calling the Server Object.

The Application Service receives the returned Device Application Data object and returns it to the Application Client.

### Application Client Operation

The Application Client 24, 28, 33, 41, contains:

(a) The Web Client for the Application Service 10, 20;

(b) Displays the content contained within the Device Application Data object as native user interface object on the Client Computer or Mobile Device 22, 27, 32, 40.

(c) The Device Application Interface 42 to interface the client with the Client Computer 40 operating system 43 functions and local devices 48, e.g. Camera, GPS location, microphone, etc.

When the Application Client 41 is launched it checks to determine the state of the user session. If the user is currently not authentication, it displays a login dialog box requesting the user to enter their credentials.

The entered credentials are sent to the Application Service 10, 20, for authentication.

(a) If the user is authenticated a Device Application Data 60 object containing the default or opening page.

(b) If the authentication fails the Device Application Data 60, Session parameters 61 will indicate authentication failed and the user will be requested to re-enter their credentials.

The Application Client 41 is device orientation aware, application and will refresh user interface display, when the Client Computer 40 display orientation changes.

The number of groups displayed at any time will change depending upon the type of computing device the Application Client 41 is running on and the orientation of the Mobile Device 40 with the objective of displaying as much data as possible while not compromising the usability of the Served Application or is native display styles.

The Application Client 41 stores lists of data objects 71 in local memory to enable the client to access this information directly or via script libraries 72.

The Application Client 41 page generation process consists of opening the client page object 62 in the Device Application Data object 60:

(c) To display the page commands 63 across the top of the page.

(d) To iterate through the page groups 64, 67 to be displayed on the page and:
(i) Generate the relevant fields controls to display the groups fields 65.
(ii) Generate the relevant page command controls to display the group specific commands 66.

(e) Where possible the Application Client 41 will display multiple Page Group objects 64, 67 on the one page.

If a page field 65, 68 requests access to a local Client Computer's 40, operating system function 43 or local device 48, the field control will:

(a) Check if the Client Computer 40 supports the requested field type, the Application Client will initiate a connection to the operating system function 43 or device 48 using the Device Application Interface 42.
(i) Displaying relevant buttons to access the local operating system function 43 or device 48. Clicking one of these buttons will execute the process needed to interact with the function or device;
(ii) For Example: a field accessing a device camera will provide a button for taking a picture. Clicking that button will open a dialog box to display the current view in the camera's lenses, with a button to take the picture and display the capture picture on the Application Client's page.

(b) If the Client Computer 40 does not support a field type, then the field's current contents will be displayed to the user as a read only data object and all enabling buttons are hidden or disabled.

When the Application Client 41 client page 62, contains more page groups 64, 67 than can be displayed on the Client Computer 40, the Application Client 41, will display a group navigation list, to enable the user to navigate between the page groups 64 67.

If the user has edit access to the Hosted Application's data to a field, the field will be edit enabled. When the user updates the field's content, the new field value will be validated locally using the passed field validation rules and the value is saved locally.

When the user clicks a Page Command button the Application Client 41 will:

(c) Attach to the Application Service 10, 20 and pass the relevant Device Application Data 60 page command object to the Application Service;

(d) The Application Service 20 will respond with a Device Application Data object 60.

When the user clicks a page command to execute a save object method:

(e) all of the field data on the page will be appended to the Page Command object as a list of parameters;

(f) the Page Command object is passed to the Application Service;

(g) The Application Service then processes the Page Command to update the application data.

### Client-Server Interaction

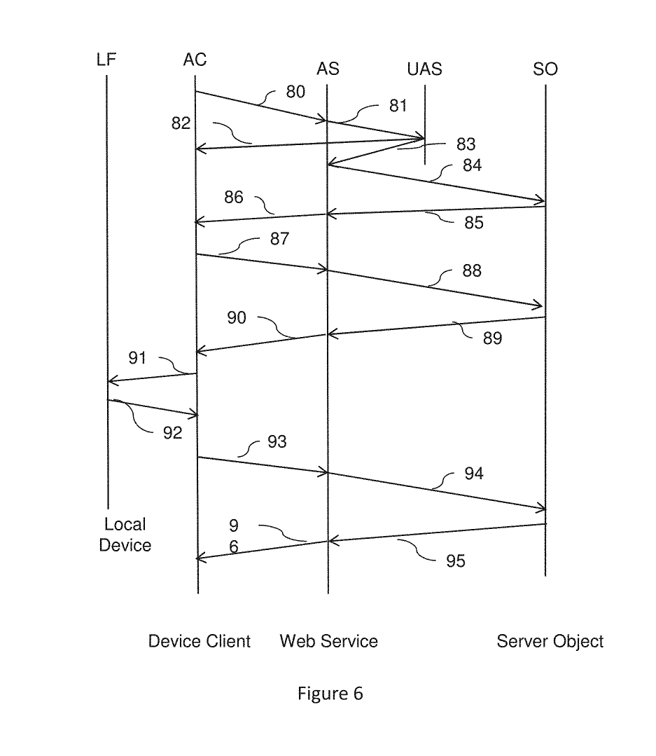

FIG. 6 describes the Application Server and Application Client interaction, consisting of connecting the client to the service, selecting a data from the Hosted Application, updating and field and saving the content via a Server Object to the Hosted Application, where:

(a) LF is a Client Computer's 40, operating system 43 or local device 48;

(b) AC is an Application Client 41;

(c) AS is an Application Service 10, 20;

(d) UAS is the user authentication service;

(e) SO is a Server Object interfacing with the Hosted Application.

When the Application Client 41 is launched, it sends an authentication request 80 to Application Service 20.

The Application Service 20 processes the request and passes the credentials 81 to the user authentication service (AS) for authentication.

(a) If the user authentication request is successful a notification 83 is sent to Application Service (AS) and a page generation request 84 is sent to Server Object (SO) to generate the default page.

(b) If the authentication request fails a request 82 to re-authenticate to the Application Client (AC).

The Server Object (SO) returns a Device Application Data object 60, to the Application Service (AS) and the Application Service (DAS) sends the Application Service (DAS) 86, to the Application Client (AC).

The user selects the application data to be retrieved the Application Client (AC) then sends the Page Command object 87, to the Application Service (AS). The Application Service (AS) processes the Page Command and then sends command 88 to the relevant Server Object (SO) to access the Hosted Application and generate the Device Application Data object 44, 60.

The Server Object (SO) returns a Device Application Data object 89, to the Application Service (AS) and the Application Service (AS) sends the Application Service (AS) 90, to the Application Client (AC).

The Device Application Data object 44, 60 is displayed on the Application Client 41. The user has data update role, allowing them to update data object values. One of the displayed fields is a camera field, displaying the current image retrieved from the Hosted Application.

The user takes a new picture, by:

(a) clicking the update image button, a message is send 91 to the Local Feature (LF) to open the camera dialog box via the Device Application Interface 42;

(b) The dialog box displays the image the camera is seeing;

(c) The user takes a picture;

(d) The picture image is passed back 92 to the Application Client 41 via the Device Application Interface 42.

To save the new image the user clicks the ‘Save’ button, the Application Client 41, appends the page field values (including the new image) into the Page Command object and passes 93 the Page Command object to Application Service (AS) method.

The Application Service (AS) processes the Page Command and passes 94 it to the relevant Server Object (SO) to be processed. The Server Object (SO) processes the Page Command then calls the relevant Hosted Application method to update the returned data.

The Served Object (SO) returns a confirmation 95 of that the data has been updated to the Application Service (AS). The Application Service (DAS) generates the relevant return Device Application Data page object and passes it back 96 to the Application Client (AC).

### Application Service Operation .Net Embodiment

The following embodiment outlines an example of implementing the Application Service 10, 20, running in a .net environment, displaying a single page at a time. In this embodiment:

(a) the Hosted Application consists of one or more assembles containing the applications executable;

(b) the Hosted Application has access to storages services such as SQL server.

(c) Active directory Services (ADS) provides the user authentication source/service.

(d) The Application Service 10, 20 is provided by IIS (Internet Information Service) running Windows server.

(e) The Web Service is running on the IIS.

In this embodiment the Device Application Data object consists of a .Net class containing:

(a) An Identifier (Global Unique Identifier)

(b) Title

(c) List of Client Pages 62 containing where each client page class contains:
(i) Identifier
(ii) Title
(iii) List of page commands classes 62 where each Page Command class contains:
   (1) Identifier
   (2) Title
   (3) Enumerated value of command types
   (4) Enumerated value of hosted application classes
   (5) Enumerated value of server object methods
   (6) List of parameters as a collection of key value pairs.
(iv) List of page groups 64, 67 where each page group class contains:
   (7) Identifier
   (8) Title
(v) List of page fields 65, 68 where each page field class contains:
   (1) Identifier
   (2) Title
   (3) Enumerated value of field data types.
   (4) Value
(vi) List of Group Page Commands 66, 69 consists of a list of Page Command class objects.

Application Service 10, 20 provides:

(a) connect to the Application Client 24, 28, 33, 41;

(b) manages the Application Client's session with the Application Service, including the authentication with the application service;

(c) interfaces to the Hosted Application, using its Server Object, classes and methods.

When the Application Service 20 receives a login request, the user's credentials are passed to the Active Directory for authentication.

(a) If the credentials are authenticated, the Application Service:
(i) creates a user an IIS user session;
(ii) the user credentials are passed to the Hosted Application to define the users access to the Hosted Application's features and functions; and
(iii) generates and returns the default page, containing the user's Session Parameters.

(b) If the authentication fails an authentication request is sent to the Application Client.

Application Service 10, 20 consists of a number of Server Objects that are used to interface the Application Service 20 with the Hosted Application. These classes provide a standardised set of functions or methods to generate and process the data that is passed between Application Service 20 and Application Client 24, 28, 33, 41, by calling the relevant Hosted Application classes and methods.

Each Application Service object has a GetPageObject method, which has Page Command class as is parameter and returns a Device Application Data class object.

A jason serialisation is used to pass data between the Application Server and the Application Client.

A Server Object class contains the application code needed to execute the Hosted Application's classes and methods. The Server Object receives one or more Page Commands object as parameters and returns the Device Application Data defining the page to be displayed on the Application Client.

Each Server Class contains four public method:

(a) getListObject method which has Page Command class as a parameter and returns a Device Application Data class object.
(i) Using the Page Command's parameter list query the Hosted Application and retrieve a list of data objects;
(ii) Iteration through the class objects to generate Device Application Object where the Page Commands, contain the parameters needed to retrieve one of the collection's objects;
(iii) The Device Application Object the returned to the calling method.

(b) getObject method which has Page Command class as a parameter and returns a Device Application Data class object:
(i) Using the Page Command's parameter list query the Hosted Application and retrieve the selected data object;
(ii) Read the class object to generate Device Application Object where the field values of the data object to be displayed on the Application Client;
(iii) The Device Application Object the returned to the calling method.

(c) createObject method which has Page Command class as a parameter and returns a Device Application Data class object:
(i) Using the Page Command's parameter list query the Hosted Application to identify and inialise the appropriate Hosted Application object;
(ii) Read the class object to generate Device Application Object where the field values of the new data object to be displayed on the Application Client;
(iii) The Device Application Object the returned to the calling method.

(d) updateObject method which has Page Command class as a parameter and returns a Device Application Data class object to display the exit page after the update. This method:
(i) extracts the field values from the Page Command's parameter list;
(ii) updates the Hosted Application's class object and passes it to the update method;
(iii) on successful completion of the update the method then generates the exit page and passes is back to the calling method.

The Application Service receives the returned Device Application Data object from the Server class object serialises it into a Jason serialisation and returns it to the Application Client.

### Application Scenarios

The invention can be used for a variety of application scenarios including:

(a) Collection of text, image, video or barcode data;

(b) Recording sounds or a conversation then saving the content in the Application Service;

(c) Location of the user collecting the data;

(d) If an iPhone, initiating a phone call;

(e) Initiating an email from the user with prefilled email content;

(f) Reading a QR barcode and then processing it content prior to passing relevant data to the Application Service;

(g) Using Bluetooth connecting an external device to Application Service via the Application Client. E.g. Accessing a vending machine, or RFID reader.

### Alternative Embodiment

The example embodiment discloses a native Application Client that is used for each application where the downloadable Device Application Data containing core executable code or instruction set, the data and the user interface, are all common across multiple platforms. Each downloadable Application Client also contains an Application Programming Interface customized for that platform and operating system to interface the Device Application Interface to the native environment for each platform.

An alternative embodiment could create an Application Client with a pre built and built in customized Device Application Interface that connects the cross platform core code to the devices operating system and components. For example, to process a photographic image to read a bar code.

Another alternative embodiment could use an existing generic application such as a web browser but to have it adapted to extend its capability to talk to the native environment with the additional functionality that is not commonly available in web browsers today. This would be the equivalent of duplicating the effect of the example embodiment of the invention.

The example embodiment uses an iPhone, iPad and a laptop as three examples of different platforms using the same multi-platform code bundle. An alternative embodiment could include the principles of the example embodiment.

### INDUSTRIAL APPLICABILITY

Embodiments of the present invention can be applied in a client server environment on a multiplicity of computing platforms, including those based on Microsoft Windows systems and Mac OS systems.

1. In a client server environment having a server with a Web service in communication with a local client, a method of tightly integrating the local client to its local operating environment residing on a platform remote from the server; said method comprising the steps of
a. installing the local client into the local operating environment;
b. requesting and receiving integrating data structures from the server; and
c. downloading the integrating data structures into the local operating environment whereby the integrating data structures define the attributes and parameters needed by the local client to define an interface between the local client and the Web service;
wherein the integrating data structures themselves are communicated between the server and the local client utilising a device independent protocol where the device independent protocol comprises a command set which is the same irrespective of the local operating environment or the platform.

2. The method of claim 1 wherein the platform is a mobile digital device or local computer with at least some of the integrating data structures are included with the local client at the time of installation and enables the Web service to have programmable access to:
a. at least some features of the local device including:
(i) data input/output;
(ii) data acquisition devices.

3. The method of claim 1 further including the step of installing the integrating data structures into the local operating environment, whereby the integrating data structures define the attributes and parameters needed by the local client to define an interface between the local client and the local operating environment, which
a. permits the local client to access features of at least one local device as if it were a native application of the local operating environment residing on the platform;
b. can include script libraries which provide a programmable interface between the local device features and the local client, and whereby the Web service has programmable access to the local device features and include a local command whose button events will call scripts to perform local processing of page data or the local devices that can be executed on all supported devices.

4. The method of claim 1 wherein the integrating data structures are implemented by the step of calling a method on the Web service and passing to it a pre-determined command object containing the command name and the parameters needed to execute the command and the Web service returns pre-determined integrating data structures relevant to the pre-determined command object, that defines:
a. the page;
b. the page groups (as a list of groups);
c. the field object containing the parameters needed to define the field type, any validation rules needed for that field, and parameter settings needed to enable or access local devices on the local client; and
d. commands that can be executed by the local client, so that, when clicked, the command button sends the relevant command object to the Web service.

5. The method of claim 4 wherein the Web service has full control of the page definitions and an unlimited number of different page definitions can be passed to the local client from the Web service; by using device independent data structures to send and receive data between the web service application and application client where the device independent data structures define the attributes and parameters needed to:
a. define the user interface;
b. access the local devices feature e.g. access to a camera connected to the platform;
c. the commands sent from the application client to the web service application.

6. The method of claim 1 wherein the web service application contains a number of server objects, to process the requests from the application client and generate the device independent data structures:
a. needed to define:
(i) the application data to be displayed on the mobile device;
(ii) any requests access to local computing features;
b. in order to:
(i) generate web service application pages using the device's native user interface;
(ii) facilitate access to the local platform features and send command requests to the web service application.

7. The method of claim 1 wherein the device client contains a device data structure:
a. to integrate the device client with local computing platform features, thereby enabling the web service application to either manually or under program control, to access the local computing platform features;
b. support the clustering of common fields to provide user navigation between field groups when using platforms comprising computing devices with small form factors while supporting multiple field data types and data validation;
c. can be extended to support the storage of application data and scripting, e.g. support JavaScript access to application functions, to:
(i) facilitate integration with common or pre-loaded data;
(ii) extend the application client's functionality that can be executed on client;
(iii) to facilitate offline operation.

8. The method of claim 1 wherein the page commands contain sufficient information to send a command to the web service application, and to identify the application objects to be accessed, the action the web service application is to perform and the parameters needed to complete the action so:
a. when a user of the web service application clicks a device client command on the user interface, the command request is sent to the web service application from the device client, to be processed by the web service application.
b. on receipt of the command request from the device client, the web service processes the command and generates the appropriate device independent data structures, which are returned to the mobile device client.

9. The method of claim 1 including the step of replacing the local client with a test harness that can execute test scripts, thereby to automate application testing.

10. The method of claim 1 wherein the platforms on which device clients can run include Microsoft Windows, Mac OS X operating systems, or a Web interface to the hosted application.

11. A digital device containing a client server environment having a server with a Web service in communication with a local client which is tightly integrated with its local operating environment residing on a platform remote from the server; the local client tightly integrated by way of integrating data structures requested and received from the server; the integrating data structures defining the attributes and parameters needed by the local client to define an interface between the local client and the Web service.

12. The digital device of claim 11 wherein the integrating data structures themselves are communicated between the server and the local client utilising a device independent protocol and the device independent protocol comprises a command set which is the same irrespective of the local operating environment or the platform.

13. The digital device of claim 11 wherein the platform is a mobile digital device or local computer containing a local application containing:
a. at least some of the integrating data structures are included with the local client at the time of installation;
b. at least some of the integrating data structures enable the Web service to have programmable access to at least some features of the local device;
c. features of the local device include input/output devices;
d. features of the local device include data acquisition devices.

14. The digital device of claim 11 further including the installation of the integrating data structures into the local operating environment, whereby the integrating data structures:
a. define the attributes and parameters needed by the local client to define an interface between the local client and the local operating environment;
b. include elements of a local device application interface, which permits the local client to access features of at least one local device as though the local client were a native application of the local operating environment residing on the platform;
c. can include script libraries which provide a programmable interface between the local device features and the local client, and whereby the Web service has programmable access to the local device features, e.g. JavaScript include:
(i) a local command whose button events will call scripts to perform local processing of page data or the local devices;
(ii) can be executed on all supported devices.

15. The digital device of claim 11 wherein the integrating data structures are implemented by:
a. the step of calling a method on the Web service and passing to it a pre-determined command object containing the command name and the parameters needed to execute the command;
b. the Web service returns pre-determined integrating data structures relevant to the pre-determined command object containing the pre-determined integrating data structures:
(i) define the page;
(ii) define the page groups (as a list of groups);
(iii) define the field object containing the parameters needed to define the field type, any validation rules needed for that field, and parameter settings needed to enable or access local devices on the local client; and
(iv) define commands that can be executed by the local client, so that, when clicked, the command button sends the relevant command object to the Web service.
c. thereby providing the Web service with full control of the page definitions and enables the web service to define an unlimited number of different page definitions can be passed to the local client from the Web service.

16. The digital device of claim 11 further including the step of utilising device independent data structures to send and receive data between the Web service application and application client where the device independent data structures define:
a. the attributes and parameters needed to define the user interface and access the local devices feature.
b. the attributes and parameters of the commands sent from the application client to the web service application.
c. access to device features such as a camera connected to the platform.

17. The digital device of claim 11 wherein the web service application contains a number of server objects, to process the requests from the application client and generate the device independent data structures needed to define the web service application data to be displayed on the mobile device and any requests access to local computing features where:
a. the device client processes the device independent data structures, in order to generate web service application pages using the device's native user interface.
b. the device client processes the device independent data structures, in order to facilitate access to the local platform features and send command requests to the web service application.
c. the device client contains a device independent interface to integrate the device client with local computing platform features, thereby enabling the web service application either manually or under program control to access the local computing platform features.

18. The digital device of claim 11 wherein the device independent data structures:
a. support the clustering of common fields to provide user navigation between field groups when using platforms comprising computing devices with small form factors while supporting multiple field data types and data validation;
b. can be extended to support the storage of application data and scripting, e.g. JavaScript, thereby to facilitate integration with common or pre-loaded data and extend the application client's functionality:
(i) to support offline operation.
(ii) to enhance the application functionality that can be executed on the client.

19. The digital device of claim 11 wherein the page commands contain sufficient information to send a command to the web service application:
a. and-to identify the application objects to be accessed, the action the web service application is to perform and the parameters needed to complete the action;
b. so when a user of the web service application clicks a device client command on the user interface, the command request is sent to the web service application from the device client, to be processed by the web service application;
c. on receipt of the command request from the device client, processes the command and generates the appropriate device independent data structures, which are returned to the mobile device client.

20. The digital device of claim 11 including the step of replacing the local client with a test harness that can execute test scripts, thereby to automate application testing.

21. The digital device of claim 11 wherein the platforms on which device clients can run include Microsoft Windows, Mac OS X operating systems, or a Web interface to the hosted application.

22. A server with a Web service; said server containing a device application interface containing a generalised data structure containing code adapted to interface multiple predetermined digital devices to an application executing on a selected one of said digital devices; said device application interface including multiple instances of code; each instance adapted to provide a tightly bound interface between said application and a said selected digital device on which a local client executes; the local client tightly integrated by way of integrating data structures requested and received from the server; the integrating data structures defining the attributes and parameters needed by the local client to define an interface between the local client and the Web service.

23. The server of claim 22 wherein said tightly bound interface is to an operating system of said selected digital device thereby to:
a. provide direct access to all input-output functions of said selected digital device and provides a user environment which appears;
b. be a native application to a user;
c. at least one instance of an application service running on a server; said application service in remote communication with an application client running on a selected digital device.
